(19) United States
(12) Patent Application Publication
(10) Pub. No.: US 2008/0028904 A1
(43) Pub. Date: Feb. 7, 2008

(54) Sealing Device Of Suction Type Placing Table

(76) Inventor: Reiji Arikita, Wakayama (JP)

Correspondence Address: HARNESS, DICKEY & PIERCE, P.L.C., P.O. BOX 8910, RESTON, VA, 20195, US

(21) Appl. No.: 11/658,678

(22) PCT Filed: Jul. 8, 2005
(86) PCT No.: PCT/JP05/12693

§ 371 Date: Jan. 29, 2007

(30) Foreign Application Priority Data
Jul. 30, 2004 (JP) 2004-223663

(51) Int. Cl. B26D 7/00

(52) U.S. Cl. 83/24; 83/100; 83/167; 83/56

(57) ABSTRACT

A sealing device of a suction type placing table directed to achieving smooth feeding and discharging of an even laminate of sheet material which largely changes in volume depending on suction and that can keep a desired cutting accuracy is provided. When a sealing device is used, in a pressing state, it is easy to satisfy a condition of the distance Ha<Hc, thus obtaining the distance Da<Dc, so that the to-be-cut material can be sufficiently covered with a sealing sheet and moreover, the cutting accuracy can be enhanced. In a non-pressing state, a condition of the distance Hb>Hc can be satisfied, thus allowing easy feeding and discharging of the to-be-cut material which may be bulky.

### TECHNICAL FIELD

The present invention relates to a sealing device of a suction type placing table which is arranged to hold a to-be-cut material under suction in cutting the to-be-cut material by a cutting machine.

### BACKGROUND ART

Conventionally, in a cutting machine 1 as shown in FIG. 6, a cutting table 3 is formed in a rectangular region on an upper face of a suction type placing table 2. In a width direction of the cutting table 3, a cutting head 5 having a cutting blade 4 reciprocates along a guide bridge 6. Assuming that a longitudinal direction of the cutting table 3 is referred to as an X-axis direction while the width direction of the cutting table 3 is referred to as a Y-axis direction, the guide bridge 6 is made to move in the X-axis direction by an X-axial moving portion 7. Two-dimensional displacement of the cutting head 5 to a surface of the cutting table 3 can be achieved in combination of an X-axial movement caused by the X-axial moving portion 7 and a Y-axial movement along the guide bridge 6. The cutting blade 4 protrudes from the cutting head 5 toward the cutting table 3 and is capable of reciprocating at high speed so that its protruding length increases and decreases.

One of the X-axial moving portions 7 is provided with, for example, a controller 8 so that an operator can perform an operation of giving an instruction about movement of the cutting machine 1. On one end and the other end in the X-axis direction of the cutting table 3 are provided a charging portion 9 and a discharging portion 10, respectively. The cutting table 3 between the charging portion 9 and the discharging portion 10 functions as a belt conveyor for conveyance in a conveyance direction 3a, and is capable of conveying a laminate of sheet material 11 from the charging portion 9 toward the discharging portion 10. On this belt conveyor are arranged blocks of hard brushes made of synthetic resin so that an upper face of the cutting table 3 is formed of tips of bristles of the hard brushes. The cutting head 5 is made to move along profile lines of parts 12 in two dimensions, that is, in the X-axis direction and Y-axis direction while the cutting blade 4 penetrates the sheet material 11 and reciprocates, with the result that the parts 12 can be cut out of the sheet material 11. In cutting with the use of the cutting blade 4, the belt conveyor needs to be halted whereby the sheet material 11 is held on the cutting table 3 so as not to move. The suction type placing table 2 has a suction mechanism therein to thereby hold the sheet material 11 under suction. The bristles forming the upper face of the cutting table 3 can be given breathability for the purpose of exerting a suction force, and moreover elastically deformed so as to avoid contact with the cutting blade 4 which penetrates the sheet material to advance into the surface of the cutting table 3.

The sheet material 11 is a cloth such as a fabric, which is soft and breathable. A plurality of such breathable sheet materials 11 are layered and then fed from the charging portion 9 onto the cutting table 3. On both sides in a width direction of the charging portion 9 are disposed stands 13 upright, across tops of which a covering sheet roll 14 is supported. When the sheet material 11 is fed from the charging portion 9, an upper face of the sheet material 11 is covered with a covering sheet 14a pulled out from the covering sheet roll 14. The covering sheet 14a is a synthetic resin film or the like which is air-impermeable. The suction force generated by the suction type placing table 2 acts on the covering sheet 14a via the sheet material 11, and in cutting with the use of the cutting blade 4, the sheet material 11 can be held on the cutting table 3. The cutting head 5 moves in the X-axis direction and Y-axis direction according to data of a shape to be cut by the cutting blade 4 such as the profile lines of the parts 12, and the cutting blade 4 is controlled so that a blade edge thereof is directed in a moving direction of the cutting head 5. The data for cutting is created in advance by a CAD apparatus or the like. For the cutting blade 4, it is possible to use not only a blade which is designed to reciprocate on a straight line but also a round blade or the like which rotates and uses its outer circumference for cutting.

After completion of the cutting of all the parts 12 out of the sheet material 11 in accordance with the cutting data, the belt conveyor of the cutting table 3 is started up, and the sheet material 11 of which parts 12 have been cut out is conveyed toward the discharging portion 10. If a work table 15 or the like has been disposed adjacent to the discharging portion 10, the sheet material 11 of which parts 12 have been cut out can be placed on the work table 15, allowing works thereon such as separation of the parts 12. During such works, a next sheet material 11 is placed on the cutting table 3, thus allowing the cutting machine 1 to perform cutting.

The covering sheet 14a is also cut at the same time of cutting of the sheet material 11, and a cut part region of the sheet material 11 becomes air-permeable. Thus, even in a case where the sheet material 11 is covered with the covering sheet 14a to have air-impermeability, the air flows from the cut part region as the cutting progresses, leading a decrease in suction force. In order to deal with this problem, a sealing device of a suction type placing table has been developed, in which regions corresponding to the already-cut parts 12 of the sheet material 11 are furthermore covered with an air-impermeable sheet to give the air-impermeability thereto (refer to, for example, Japanese Examined Patent Publication JP-B2 2654491).

FIG. 7 shows a schematic configuration of a sealing device of a suction type placing table disclosed in JP-B2 2654491. A part corresponding to that in the configuration shown in FIG. 6 will be denoted by the same reference numeral, and overlapping descriptions will be omitted. Relative to the sheet material 11 fed from the charging portion 9 of the cutting table 3, the cutting head 5 is made to move in the X-axis direction from the discharging portion 10-side to the charging portion 9-side and while doing so, the parts 12 are sequentially cut. On the X-axial moving portion 7 is disposed a bracket 16 so as to protrude toward the discharging portion 10. On an end of the bracket 16 is rotatably supported a sealing sheet roll 17. On the sealing sheet roll 17 is wound up an air-impermeable sealing sheet 17a such as a synthetic resin film. An end of the sealing sheet 17a is fixed on an upper part of a holding arm 18 which is disposed upright on the discharging portion 10-side. Inside the bracket 16 is disposed a mechanism for driving the sealing sheet roll 17 to rotate in a reeling-off direction or winding-up direction of the sealing sheet 17a, in conjunction with its reciprocating movement in the X-axis direction caused by the X-axial moving portion 7. That is to say, the sealing sheet 17a for covering already-cut parts of a to-be-cut material, namely the sheet material 11, and the covering sheet 14a has its one end fixed on an already-cut-side end of the suction type placing table 2 and the other end provided with the sealing sheet roll 17 which is disposed so as to reel off or wind up the sealing sheet 17a in conjunction with the movement of the cutting blade 4 in a longitudinal direction of the cutting table 3.

In addition, there has been proposed a configuration that a part corresponding to the holding arm 18 shown in FIG. 7 can be displaced upward and downward, and even in the middle of cutting, the suction conducted by the suction type placing table 2 is stopped and the end of the sealing sheet 17a is made to move upward to thereby peel off the sealing sheet 17a from the upper face of the to-be-cut material, allowing accesses such as inspection of the cut parts 12 (refer to, for example, Japanese Examined Patent Publication JP-B2 63-31355 (1988) and Japanese Unexamined Patent Publication JP-A 6-8192 (1994)). Note that a part of JP-B2 63-31355 corresponding to the sealing sheet roll 17 is just biased against its winding-up side by a spring. Moreover, in JP-A 6-8192 is disclosed a configuration that the sealing sheet roll 17 is guided by a slope to thus move upward as well when a part corresponding to the X-axial moving portion 7 reaches to a part corresponding to the discharging portion 10, whereby the sealing attained by an air-impermeable sheet corresponding to the sealing sheet 17a is released.

A lamination thickness of the seat material 11 may be varied to a large degree between before and after the suction which is effected by the suction type placing table 2. A change of the lamination thickness caused by the suction is large when the to-be-cut material is formed by laying the covering sheet 14a on the laminate of sheet material which is elastic, such as a sponge material, cotton, a sponge-backed car sheet material, and a cloth containing inner cotton. That is to say, when the to-be-cut material is fed onto the suction type placing table 2 or discharged from the suction type placing table 2, the suction force is not exerted and therefore, the to-be-cut material becomes bulky. When the suction force is exerted by feeding the to-be-cut material onto the cutting table 3, the sheet material 11 is compressed between the covering sheet 14a and the cutting table 3, thus becoming less bulky. As shown in FIG. 6, in a case where the sealing sheet 17a as shown in FIG. 7 is not used, the parts 12 become less absorptive due to air leakage from the profile lines of the parts 12 after completion of the cutting, and parts of the sheet material 11 corresponding to that parts 12 become bulky, thus causing the parts 12 to form a bump.

As shown in FIG. 7, in a case where the sealing sheet 17a is used, the sealing sheet roll 17 needs to be positioned sufficiently high above the cutting table 3 in order to smoothly feed the to-be-cut material which is bulky, from the charging portion 9 onto the cutting table 3. When the lamination thickness of the to-be-cut materials is equal to or larger than a distance between a lower end of the sealing sheet roll 17 and the upper face of the cutting table 3, the sealing sheet roll 17 becomes impeditive to feeding and discharging of the to-be-cut material, thus deteriorating workability thereof. Accordingly, the level of the sealing sheet roll 17 needs to be high enough from the upper face of the cutting table 3.

However, when the level of the sealing sheet roll 17 is high, the surface of the to-be-cut material slopes up as seen on the holding arm 18-side, with the result that an end position where the to-be-cut material is covered is shifted away from a position just beneath the sealing sheet roll 17 toward the discharging portion 10. When viewed in the X-axis direction, a position of the sealing sheet roll 17 is preferably as close as possible to a position where the cutting is carried out by the cutting head 5 whereas the bracket 16 must be positioned to a certain extent away from the cutting position. An increase in level of the sealing sheet roll 17 leads a decrease in area of an already-cut-region which can be covered with the sealing sheet 17a.

FIG. 8 schematically shows a layout of a plurality of parts 12a, 12b, 12c, 12d, 12e, 12f, 12g, etc. which are to be cut out of the sheet material 11 placed on the cutting table 3. Although the parts 12 to be cut actually are often different in size and shape from each other, all the parts 12 shown have the same shape for convenience of explanation. On the cutting table 3, for example, assuming that a lower end position in the discharging portion 10 in the figure is an origin, the cutting starts from the part 12a close to the origin, sequentially to the parts 12b and 12c which are adjacent in the Y-axis direction, followed by cutting of the part 12d adjacent in the X-axis direction and further cutting of the parts 12e and 12f adjacent in the Y-axis direction. In the figures is shown the part 12g further adjacent in the X-axis direction, which is being cut by the cutting head 5. The sealing sheet roll 17 is positioned away from the X-axial moving portion 7 toward the origin by a length of the bracket 16. When the level of the sealing sheet roll 17 above the upper face of the cutting table 3 is as high as that of the holding arm 18, an actual area of the sealing sheet 17a covering the to-be-cut material is, as shown in diagonal strokes, located closer to the discharging portion 10 rather than the sealing sheet roll 17. As a result, the parts 12d, 12c and 12f of which cuttings have been completed are not able to be sealed, thus leading a decrease in suction force. The elastic sheet material 11 which is bulky in an uncompressed state may form a bump.

The bumps of the cut parts 12 accompanies slopes therearound. Cutting of the slopes by use of the cutting blade 4 causes a vertical shift of the cutting position of the laminate of sheet material 11, thus affecting a cutting accuracy.

### DISCLOSURE OF INVENTION

An object of the invention is to provide a sealing device of a suction type placing table, that can achieve smooth feeding and discharging of even a laminate of sheet material which largely changes in volume depending on suction and that can keep a desired cutting accuracy.

The invention provides a sealing device of a suction type placing table, in which in cutting a laminate of soft sheet material held on the suction type placing table, with the use of a cutting blade moving along a surface of the suction type placing table, according to a travel distance of the cutting blade from one end of the suction type placing table, an air-impermeable sheet is fed from a feeding component disposed on the cutting blade side, to the one end of the suction type placing table so that a surface of the laminate of sheet material is covered with the air-impermeable sheet to achieve sealing, and

the feeding component is adapted to feed the air-impermeable sheet toward a surface of the suction type placing table at a position which is above the surface of the suction type placing table by a distance,

the sealing device comprising a pressing mechanism disposed adjacent to the feeding component, that is switchable between a pressing state of pressing downward a surface of the air-impermeable sheet fed toward the suction type placing table, and a non-pressing state of not pressing the surface of the air-impermeable sheet,

wherein the pressing state of the pressing mechanism is adapted such that a position at which the air-impermeable sheet covers the surface of the sheet material placed on the suction type placing table, is closer to the cutting blade than the position in the non-pressing state is.

Further, in the invention it is preferable that the pressing mechanism can change a position of downwardly pressing the surface of the air-impermeable sheet in the pressing state, corresponding to a height from the surface of the suction type placing table.

Further, in the invention it is preferable that the pressing mechanism comprises:

a pressing member which comes into contact with the surface of the air-impermeable sheet in the pressing state; and

a swinging member which supports the pressing member at a moving end and is swingingly displaceable so as to move the pressing member away from the surface of the air-impermeable sheet.

Further, in the invention it is preferable that a supporting point for the swinging member which exists at a proximal end of the swinging member is located farther away from the feeding component toward the cutting blade side than a position at the moving end in the non-pressing state is.

Further, in the invention it is preferable that the pressing member is a rotatable roller of which outer circumferential surface comes into contact with the surface of the air-impermeable sheet.

### BRIEF DESCRIPTION OF DRAWINGS

Other and further objects, features, and advantages of the invention will be more explicit from the following detailed description taken with reference to the drawings wherein:

FIGS. 1A to 1C are schematic sectional side views showing simplified configurations of main part of a sealing device 21 according to one embodiment of the invention, and moreover a conventional configuration for comparison;

FIG. 2 is a side sectional view showing in more detail the configuration of the sealing device 21 shown in FIGS. 1A to 1C;

FIG. 3 is an overhead plan view showing a configuration which substantially corresponds to the configuration shown in FIG. 2;

FIGS. 4A and 4B are left side views of a bracket 26 shown on a right side in FIG. 3;

FIGS. 5A and 5B are right side views of a bracket 26 shown on a left side in FIG. 3;

FIG. 6 is a perspective view showing a configuration of a conventional cutting machine;

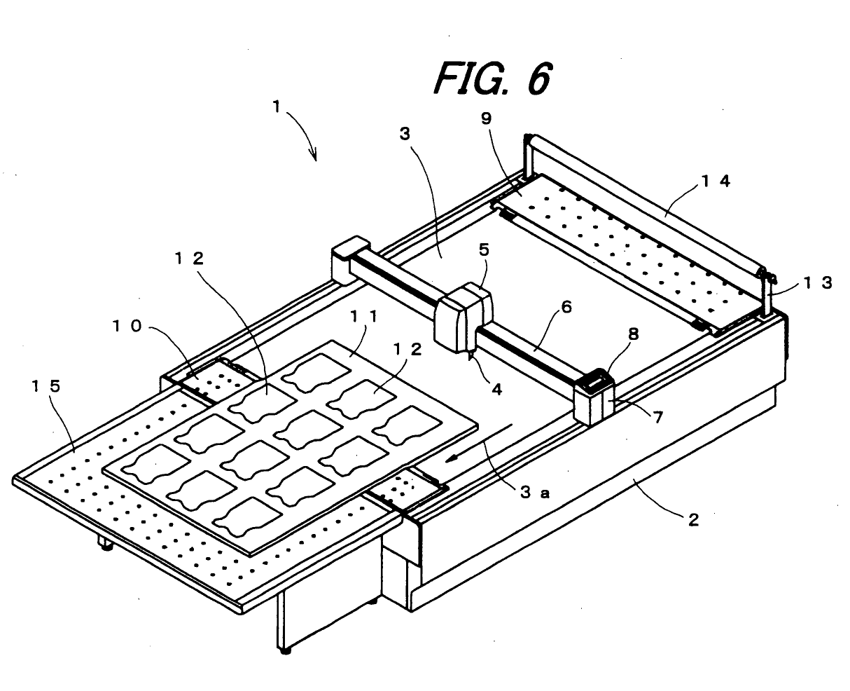

FIG. 7 is a side view showing a schematic configuration of a sealing device of a suction type placing table according to a prior art; and

FIG. 8 is a plan view schematically showing a layout of a plurality of parts 12a, 12b, 12c, 12d, 12e, 12f, 12g, etc. which are to be cut out of a sheet material 11 placed on a cutting table 3 shown in FIG. 7.

### BEST MODE FOR CARRYING OUT THE INVENTION

Now referring to the drawings, preferred embodiments of the invention are described below.

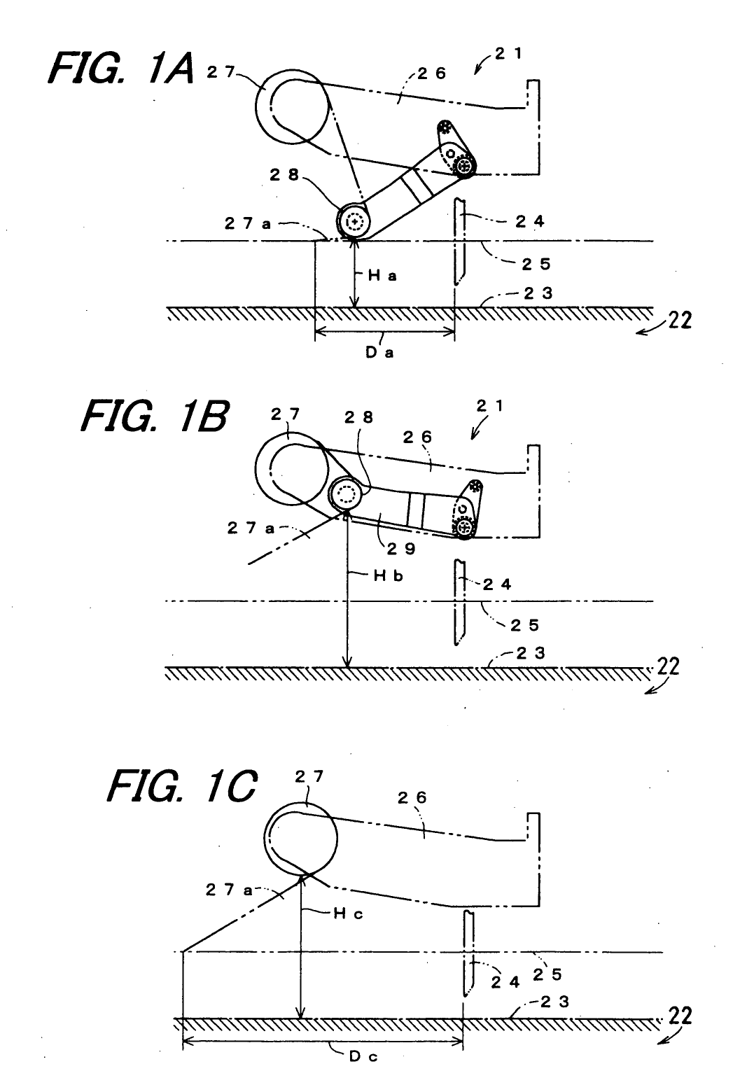

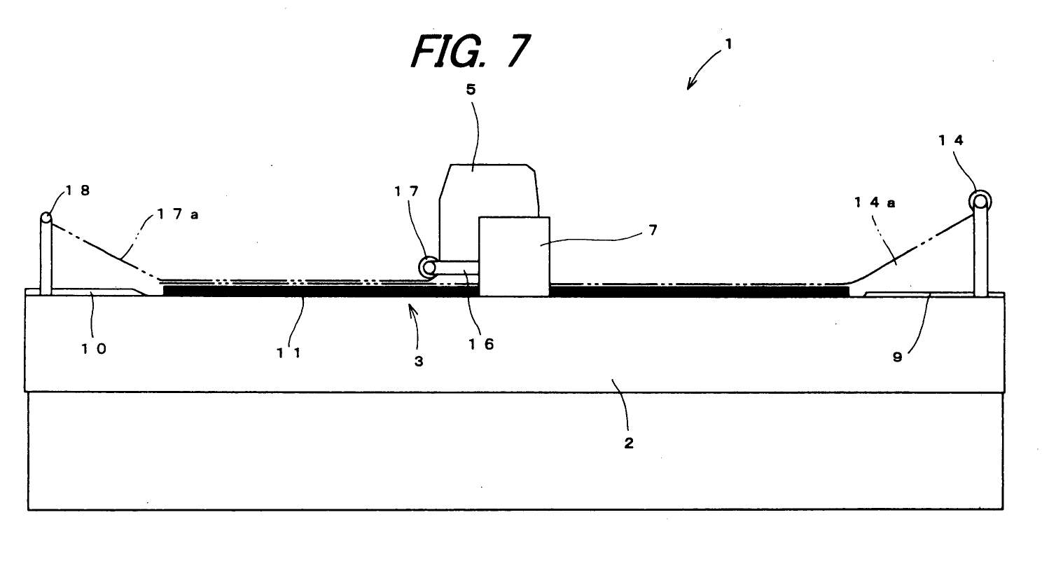

FIGS. 1A to 1C show simplified configurations of main part of a sealing device 21 according to one embodiment of the invention, and moreover a conventional configuration for comparison. More specifically, FIG. 1A shows a pressing state, FIG. 1B shows a non-pressing state, and FIG. 1C shows a prior art. Configurations of components other than the sealing device 21 in a cutting machine employing the sealing device 21 are basically the same as those in the cutting machine 1 shown in FIG. 7.

The sealing device 21 shown in FIG. 1A and FIG. 1B is used when a to-be-cut material 25 is cut by a cutting blade 24, on a cutting table 23 formed on a suction type placing table 22 which is basically the same as the suction type placing table 2 in the cutting machine 1 as shown in FIG. 7. The to-be-cut material 25 is basically the same as the sheet material 11 covered with a covering sheet 14a shown in FIG. 7. A bracket 26 which protrudes toward an X origin from a component equivalent to an X-axial moving portion 7 shown in FIG. 7, feeds a sealing sheet 27a made of, for example, an air-impermeable synthetic resin film onto a surface of the to-be-cut material 25 from a sealing sheet roll 27 held on a distal end of the bracket 26. In the sealing device 21, a press roller 28 is disposed adjacent to the sealing sheet roll 27 as a pressing member. The press roller 28 is rotatably supported at a distal end portion of a swinging arm 29 which swings to be thus displaced about a proximal end shaft provided at a middle portion of the bracket 26. FIG. 1A shows a pressing state where the swinging arm 29 has its distal end being lowered so that the press roller 28 comes into contact with the sealing sheet 27a, and the sealing sheet 27a is made to approach a position close to the cutting blade 24 to then cover the to-be-cut material 25. FIG. 1B shows a non-pressing state where the swinging arm 29 swings to be thus displaced so that the distal end portion of the swinging arm 29 has moved up to a position of the bracket 26. FIG. 1C shows a conventional configuration where the press roller 28 and the swinging arm 29 are not used.

In FIG. 1A, a distance between a position at which the sealing sheet 27a covers the to-be-cut material 25, and the cutting blade 24 is represented by Da, and a distance between a lower end of the press roller 28 and an upper face of the cutting table 23 is represented by Ha. In FIG. 1B, a distance between the lower end of the press roller 28 and the upper face of the cutting table 23 is represented by Hb. In the non-pressing state, the press roller 28 may also move up so that a lower end thereof is positioned above a lower end of the sealing sheet roll 27. In this case, the distance Hb represents a distance between the lower end of the sealing sheet roll 27 and the upper face of the cutting table 23. In FIG. 1C, a distance between a position at which the sealing sheet 27a covers the upper face of the to-be-cut material 25, and the cutting blade 24 is represented by Dc, and a distance between the lower end of the sealing sheet roll 27 and the upper face of the cutting table 23 is represented by Hc.

With the configuration as shown in FIG. 1C, particularly in a case of cutting a highly compressive sheet material, an attempt to secure the distance Hc long enough to facilitate feeding and discharging of the to-be-cut material 25 causes an increase of the distance Dc, resulting in deterioration of cutting accuracy. When the sealing device 21 is used, in the pressing state shown in FIG. 1A, it is easy to satisfy a condition of the distance Ha<Hc, thus obtaining the distance Da<Dc, so that the to-be-cut material 25 can be sufficiently covered with the sealing sheet 27a and moreover, the cutting accuracy can be enhanced. In the non-pressing state shown in FIG. 1B, a condition of the distance Hb>Hc can be satisfied, thus allowing easy feeding and discharging of the to-be-cut material 25 which may be bulky.

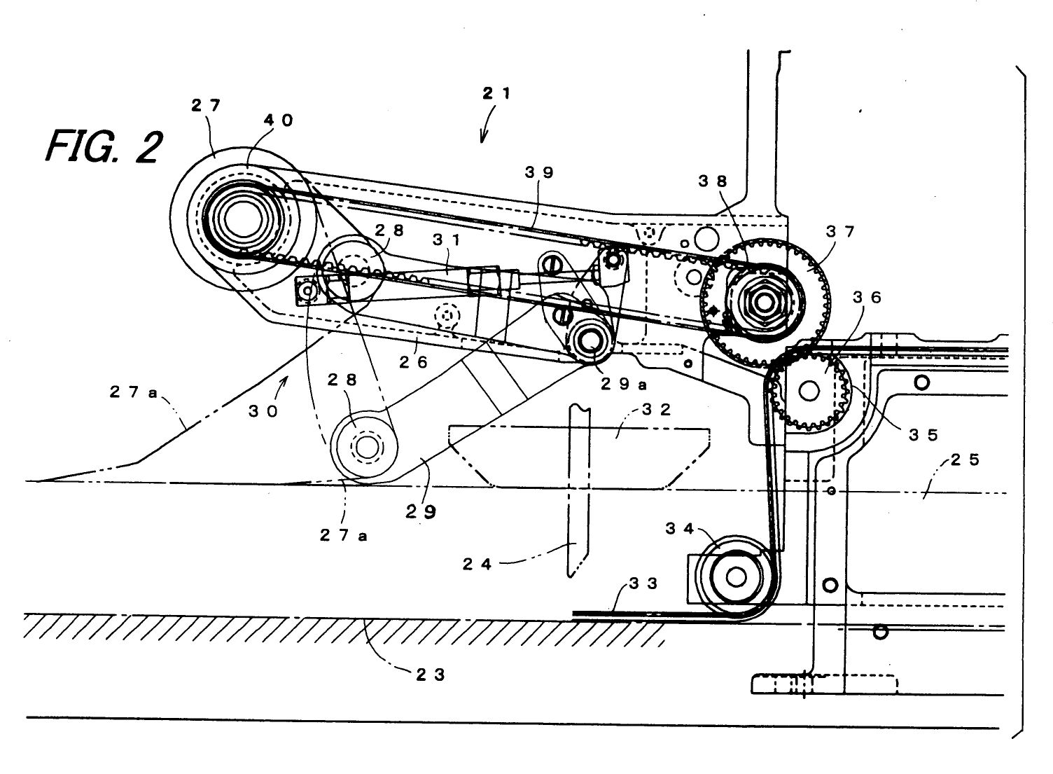

FIG. 2 shows in more detail the configuration of the sealing device 21 shown in FIGS. 1A to 1C. Basically, the non-pressing state is shown while a pressing state is drawn in a thin line. The press roller 28 and the swinging arm 29 are contained in a pressing mechanism 30. The pressing mechanism 30 further comprises a cylinder 31 and an after-described spring or the like. The swinging arm 29 has its proximal end provided with a swinging shaft 29a and is thereby swingably supported at the middle portion of the bracket 26. At the distal end of the swinging arm 29 is supported a shaft of the press roller 28 which is thus rotatable. At the proximal end of the swinging arm 20 is formed a driving arm extending therefrom, of which length is shorter than a distance between the swinging shaft 29a and the press roller 28. On an end of the driving arm is coupled an end of a rod of the cylinder 31. The cylinder 31 has its proximal end of which shaft is supported by the bracket 26 adjacent to the sealing sheet roller 27 so that the cylinder 31 can swing to be thus displaced. The cylinder 31 extends and contracts by fluid pressure such as air pressure. The extended cylinder 31 presses the driving arm of the swinging arm 29 against the bracket 26 at its proximal end to thereby give a torque to the swinging arm 29 around the swinging shaft 29a so as to move up the press roller 28 provided at the distal end of the swinging arm 29.

To the pressing mechanism 30 as described above, various configurations may be applicable. For example, the cylinder 31 using the fluid pressure can be replaced by a mechanism such as a ball screw. Furthermore, it is also possible to use an angular displacement actuator which gives a torque directly to the swinging shaft 29a. In this regard, when the mechanism as shown is used, the pressing mechanism 30 can be formed into a smaller configuration, and in the non-pressing state as shown, the swinging arm 29 can be hidden behind the bracket 26 when viewed from its side. When the rod of the cylinder 31 contracts, a torque is applied to the swinging arm 29 such that the press roller 28 moves downward, resulting in the pressing state indicated in the thin line in the figure.

While cutting, a cloth retainer 32 presses a circumference around a cutting position at which the cutting blade 24 penetrates the to-be-cut material 25, thereby preventing the to-be-cut material 25 from forming a bump due to reciprocating up-and-down motion of the cutting blade 24. The press roller 28 in the pressing state can be brought close to the cutting blade 24 unless it does not interfere with the cloth retainer 32. Moreover, the press roller 28 is designed to have its lower end positioned a little above the upper face of the to-be-cut material 25 so that the lower end does not come into contact with the upper face of the to-be-cut material 25.

As disclosed in Japanese Examined Patent Publication JP-B2 2654491, the sealing sheet roll 27 is driven to rotate so as to be capable of feeding and collecting the sealing sheet 27a by reeling off the sealing sheet 27a toward the cutting table 23 and winding up the sealing sheet 27a from the cutting table 23 in conjunction with X-axial reciprocating motion of the cutting blade 24. Such a driving force of the sealing sheet roll 27 is generated by a relative movement of the sealing sheet roll 27 with respect to a belt 33 stretched in the X-axis direction over one side of the cutting table 23. That is to say, a part of the belt 33 is pulled into a component equivalent to the X-axial moving portion 7 shown in FIG. 7, and a direction of the belt 33 is changed at a pulley 34 into an upward direction and further changed at a pulley 35 into a crosswise direction. The same kinds of the pulleys 34 and 35 are disposed symmetrically on the right side of the figure so that a level of the belt 33 is brought back to the same level of the side of the cutting table 23. The pulleys 34 and 35 rotate by the X-axial movement. On the pulley 35 positioned at an X origin-side is coaxially provided a gear 36 which engages with a gear 37 provided at a proximal part of the bracket 26. On the gear 37 is coaxially provided a pulley 38 around which a part of an endless belt 39 is looped. When viewed from the side, the belt 39 is housed in a back side of the bracket 26, and the other part of the belt 39 is looped around a pulley 40 provided coaxially with the sealing sheet roller 27. The drive of the sealing sheet roller 27 effected by the belt 39 leads synchronization of an X-axial travel distance of the cutting blade 24 and a reeled-off or wound-up length of the sealing sheet 27a. Furthermore, the engaging gears 36 and 37 can change the speed therebetween, for example, decelerating. A change gear ratio may be set in accordance with an outer diameter of the sealing sheet roll 27. Note that, as the press roller 28, there is used a continuous roller of which outer diameter is uniform in the Y-axis direction, but there may be used a roller, a part of which has a shorter diameter. The press roller 28 may be composed of small rollers which are coupled on each other by a shaft of shorter diameter.

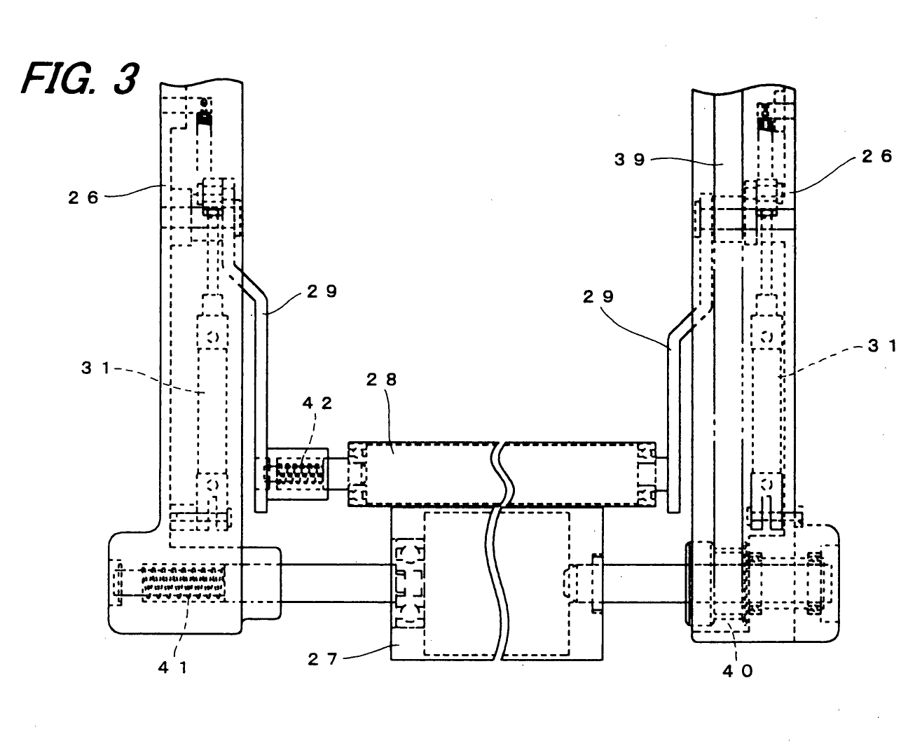

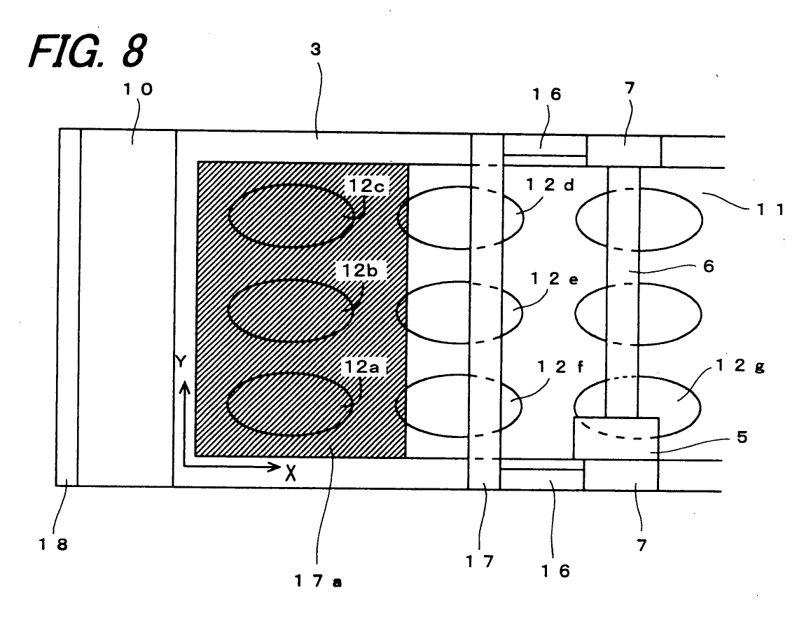

FIG. 3 is an overhead plan view showing a configuration which substantially corresponds to the configuration shown in FIG. 2. As in the case of FIG. 8, positive directions of X axis and Y axis are set respectively. An upward direction of the figure is the positive direction of X axis while a leftward direction of the figure is the positive direction of Y axis. The pressing mechanism 30 including the swinging arm 29, the cylinder 31, and the press roller 28 is provided respectively on both sides in the positive and negative directions of the Y axis of the bracket 26. A rotational driving mechanism of the sealing sheet roll 27 including the belt 39 and the pulley 40 is provided on either side of the positive and negative directions of the Y axis, for example, provided on an origin-side in the negative direction in the bracket 26. In the bracket 26 on the other side is housed a spring 41 for pressing a support portion for supporting the sealing sheet roll 27 so as to be rotatable. When the sealing sheet roller 27 is pressed against the bracket 26 on this side, the spring 42 contracts whereby the sealing sheet roller 27 can be detached. The press roller 28 is also pressed in a direction of Y origin by a spring 42, and when pressed in a reverse direction to thereby cause the spring 42 to contract, the press roller 28 can be detached form the swinging arm 29.

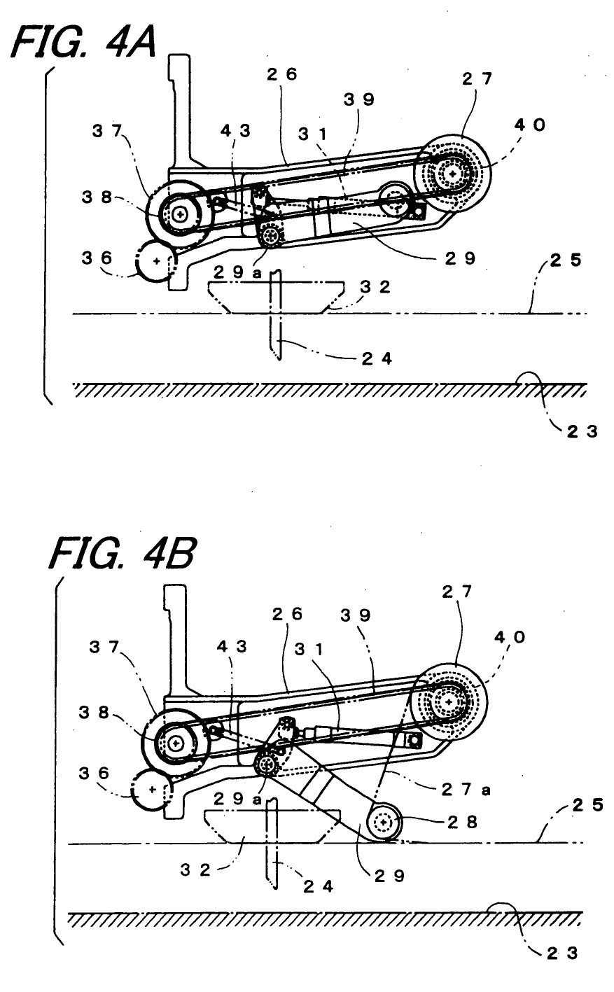

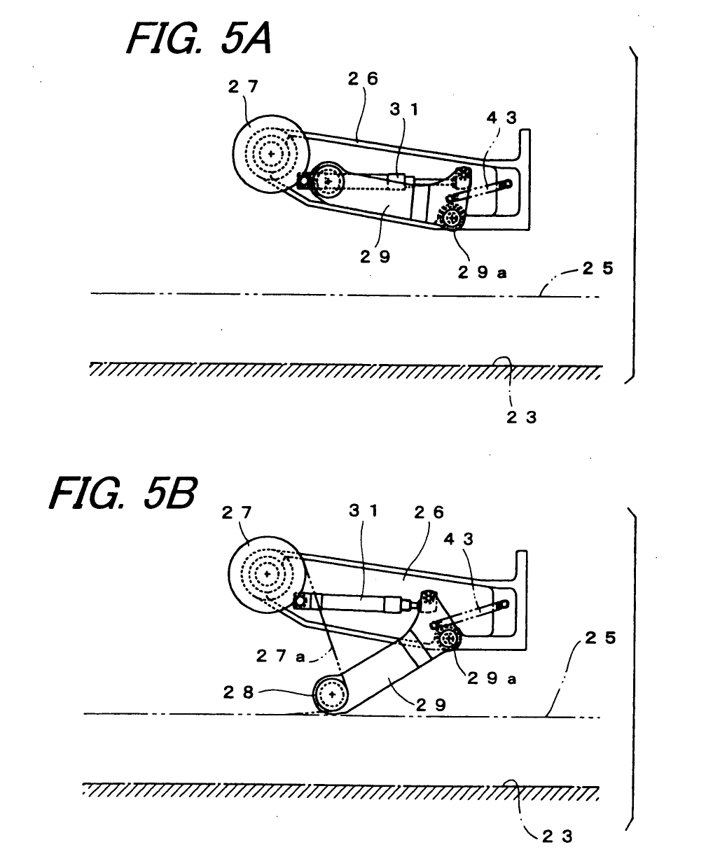

FIGS. 4A, 4B, 5A, and 5B show a configuration provided on the back side of the bracket 26 when viewed from its side, on which the rotational driving mechanism of the sealing sheet roller 27 is provided, and a configuration provided on the back side of the bracket 26 when viewed from its side, on which the rotational driving mechanism of the sealing sheet roller 27 is not provided. That is to say, FIGS. 4A and 4B show a right part of the configuration shown in FIG. 3 when viewed from its left side, and FIGS. 5A and 5B show a left part of the configuration shown in FIG. 3 when viewed from-its right side. FIG. 4A and FIG. 5A show the non-pressing state of the press roller 28. FIG. 4B and FIG. 5B show the pressing state of the press roller 28. Between a proximal end of the swinging arm 29 and the bracket 26 is provided a spring 43 which puts tension therebetween. The spring 43 serves as an assist for swinging the press roller 28 upward. By adding bias force of the spring 43 to thrust of the cylinder 31, even the cylinder 31 of which thrust is small can be made to swing upward against a weight of the press roller 28 so that the non-pressing state can be brought. The spring 43 can be utilized in a way such that the non-pressing state is maintained even in a state where the cylinder 31 is free from the action of fluid pressure.

That is to say, the sealing device 21 of the suction type placing table 22, which effects sealing by feeding the sealing sheet 27a from the sealing sheet roll 27 in accordance with the travel distance of the cutting blade 24 to cover therewith the surface of the to-be-cut material 25, comprises the pressing mechanism 30 which is designed to allow feeding of the sealing sheet 27a at a position above the upper face of the cutting table 23 by a distance Hb. The press roller 28 is disposed adjacent to the sealing sheet roll 27, and switchable between the pressing state of pressing downward the surface of the sealing sheet 27a fed toward the suction type placing table 22, and the non-pressing state of not pressing the surface of the sealing sheet 27a. In the pressing state of the press roller 28, the position at which the sealing sheet 27a covers the surface of the to-be-cut material 25 placed on the suction type placing table 22, can be close to the cutting blade 24 compared to the case of the non-pressing state. By proceeding cutting of the to-be-cut material 25 from one end to the other end of the suction type placing table 22, for example, in the X-axis direction of the cutting table 23, the sealing sheet 27a covering an already-cut region can be brought close to a part being cut by the cutting head as the cutting progresses, resulting in effective sealing so that a favorable cutting accuracy is obtained. When the sealing sheet roller 27 is positioned high above the surface of the suction type placing table 22 upon shifting the press roller 28 to the non-pressing state, the sealing sheet roller 27 never be impeditive to feeding and discharging of bulky to-be-cut material 25 which is compressible, so that the operation can be smoothly carried out.

Further, the pressing mechanism 30 may be configured such that a position at which the press roller 28 in the pressing state presses the sealing sheet 27a, that is, a height from the surface of the cutting table 23 can be changed. For example, when a motor is used for driving the swinging arm 29 to swing and be thus displaced, a press position can be easily changed. The cutting machine has a setting of acceptable lamination thickness, and the level of the sealing sheet roll 27 or the like is set at an optimum value in light of the acceptable lamination thickness. When the press position of the press roller 28 is made variable in the pressing mechanism 30, the sealing sheet 27a can be fed from an appropriate level even in a case where the to-be-cut material 25 having a lamination thickness of about 2.5 cm (about 1 inch) is cut by the cutting machine having an acceptable lamination thickness of about 5 cm (about 2 inches), for example. By providing the cutting head with measurement means for measuring the lamination thickness as the applicant of the invention has disclosed in Japanese Unexamined Patent Publication JP-A 7-60686 (1995), the press position can be automatically changed in accordance with the lamination thickness.

Further, the distal end of the swinging arm 29 in the pressing state is close to the sealing sheet roll 27 and positioned high above the surface of the cutting table 23 while the distal end of the swinging arm 29 in the non-pressing state is close to the cutting blade 24 and positioned low above the surface of the cutting table 23, thus allowing effective switching.

Further, the press roller 28 serving as a pressing member is a rotatable roller of which outer circumferential surface comes into contact with the surface of the sealing sheet 27a which is an air-impermeable sheet, so that the air-impermeable sheet can be easily fed in and out from a feeding component even in the pressing state. For the pressing member, also applicable is a pressing member which does not rotate but just contacts the surface of the sealing sheet 27a. Moreover, the pressing may also be achieved without the contact by the action of air pressure or the like.

The invention may be embodied in other various forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, in a pressing state of a pressing mechanism, a position at which an air-impermeable sheet covers a surface of a sheet material placed on a suction type placing table, can be close to a cutting blade compared to a case of a non-pressing state. By proceeding cutting of a to-be-cut material from one end to the other end of the suction type placing table, the air-impermeable sheet covering an already-cut region can be brought close to a part being cut by the cutting blade as the cutting progresses, resulting in effective sealing so that a favorable cutting accuracy is obtained. When a feeding component is positioned high above a surface of the suction type placing table upon shifting the pressing mechanism to the non-pressing state, the feeding component never be impeditive to feeding and discharging of uncompressed bulky sheet material which can be compressed to be less bulky, so that the operation can be smoothly carried out.

Further, according to the invention, it is possible to change a level of a position above the surface of the suction type placing table, at which position the surface of the air-impermeable sheet is pressed downward in the pressing state.

Further, according to the invention, when a swinging member is made to swing so as to be displaced to thereby bring a pressing member to the non-pressing state, the feeding component never be impeditive to feeding and discharging of a bulky sheet material which is compressible, so that the operation can be smoothly carried out. When the pressing member is brought to the pressing state, a position of sealing effected by the air-permeable sheet is brought close to a part being cut by the cutting blade, resulting in effective sealing so that a favorable cutting accuracy is obtained.

Further, according to the invention, in the non-pressing state, the pressing member can be brought close to the feeding component, and in the pressing state, the pressing member can be brought close to the cutting blade.

Further, according to the invention, the pressing member is a rotatable roller of which outer circumferential surface comes into contact with the surface of the air-impermeable sheet, so that the air-impermeable sheet can be easily fed in and out from the feeding component even in the pressing state.

1. A sealing device of a suction type placing table, in which in cutting a laminate of soft sheet material held on the suction type placing table, with the use of a cutting blade moving along a surface of the suction type placing table, according to a travel distance of the cutting blade from one end of the suction type placing table, an air-impermeable sheet is fed from a feeding component disposed on the cutting blade side, to the one end of the suction type placing table so that a surface of the laminate of sheet material is covered with the air-impermeable sheet to achieve sealing, and
the feeding component is adapted to feed the air-impermeable sheet toward a surface of the suction type placing table at a position which is above the surface of the suction type placing table by a distance,
the sealing device comprising a pressing mechanism disposed adjacent to the feeding component, that is switchable between a pressing state of pressing downward a surface of the air-impermeable sheet fed toward the suction type placing table, and a non-pressing state of not pressing the surface of the air-impermeable sheet,
wherein the pressing state of the pressing mechanism is adapted such that a position at which the air-impermeable sheet covers the surface of the sheet material placed on the suction type placing table, is closer to the cutting blade than the position in the non-pressing state is.

2. The sealing device of claim 1, wherein the pressing mechanism can change a position of downwardly pressing the surface of the air-impermeable sheet in the pressing state, corresponding to a height from the surface of the suction type placing table.

3. The sealing device of claim 1, wherein the pressing mechanism comprises:
a pressing member which comes into contact with the surface of the air-impermeable sheet in the pressing state; and
a swinging member which supports the pressing member at a moving end and is swingingly displaceable so as to move the pressing member away from the surface of the air-impermeable sheet.

4. The sealing device of claim 3, wherein a supporting point for the swinging member which exists at a proximal end of the swinging member is located farther away from the feeding component toward the cutting blade side than a position at the moving end in the non-pressing state is.

5. The sealing device of claim 3, wherein the pressing member is a rotatable roller of which outer circumferential surface comes into contact with the surface of the air-impermeable sheet.

6. The sealing device of claim 2, wherein the pressing mechanism comprises:
a pressing member which comes into contact with the surface of the air-impermeable sheet in the pressing state; and
a swinging member which supports the pressing member at a moving end and is swingingly displaceable to as to move the pressing member away from the surface of the air-impermeable sheet.

7. The sealing device of claim 4, wherein the pressing member is a rotatable roller of which outer circumferential surface comes into contact with the surface of the air-impermeable sheet.
